(19) United States
(12) Patent Application Publication
(10) Pub. No.: US 2026/0147088 A1
(43) Pub. Date: May 28, 2026

(54) GHOST TARGET EXTRACTION METHOD AND APPARATUS FOR BPSK-BASED MIMO FMCW RADAR SYSTEM

(71) Applicant: CHUNG ANG UNIVERSITY INDUSTRY ACADEMIC COOPERATION FOUNDATION, Seoul (KR)

(72) Inventors: Seong Wook LEE, Seoul (KR); Jun Ho KIM, Seoul (KR)

(21) Appl. No.: 19/452,324

(22) Filed: Jan. 18, 2026

Related U.S. Application Data
(63) Continuation of application No. PCT/KR2023/020510, filed on Dec. 13, 2023.

(30) Foreign Application Priority Data
Jul. 18, 2023 (KR) 10-2023-0093329

(51) Int. Cl. G01S 7/35

(52) U.S. Cl. CPC G01S 7/354

(57) ABSTRACT

An FMCW radar-based target extraction method comprises: (a) transmitting a radar transmit signal, the radar transmit signal being BPSK (binary phase shift keying)-modulated based on a first binary code; (b) acquiring a radar receive signal reflected by a target; (c) multiplying the radar receive signal by a second binary code to generate a ghost-target signal; and (d) removing the ghost-target signal from the radar receive signal to extract a real target signal.

### CROSS-REFERENCES TO RELATED APPLICATION

This application is a bypass continuation of pending PCT International Application No. PCT/KR2023/020510, which was filed on Dec. 13, 2023, and which claims priority to Korean Patent Application No. 10-2023-0093329, which was filed in the Korean Intellectual Property Office on Jul. 18, 2023. The disclosures of which are hereby incorporated by reference in their entireties.

### TECHNICAL FIELD

The present disclosure relates to an FMCW (frequency-modulated continuous wave) radar-based target extraction method and apparatus.

### BACKGROUND ART

In automotive radar systems, MIMO (multiple-input multiple-output) FMCW radar systems employing virtual antenna array techniques are predominantly used for high-resolution angle estimation, rather than physically increasing the number of antennas.

To estimate a target's range, velocity, and angle using such a MIMO FMCW radar system, the receiver must distinguish signals transmitted from the respective antenna elements. Accordingly, the antenna system adopts time-division multiplexing (TDM), frequency-division multiplexing (FDM), or code-division multiplexing (CDM) for transmitting FMCW radar signals.

Currently, TDM-based MIMO schemes are the most widely used; however, in TDM-based MIMO FMCW radar systems, the maximum detectable velocity decreases in proportion to the number of transmit antennas. In addition, time delays between waveforms transmitted from different antenna elements significantly degrade angle-estimation accuracy.

To address the shortcomings of TDM-based MIMO FMCW radar systems, a BPSK (binary phase shift keying)-based MIMO FMCW radar system can be considered. In a BPSK-based MIMO FMCW radar system, signals with binary phase modulation are transmitted. The reduction in maximum detectable velocity can be avoided through binary phase modulation; however, ghost targets are then detected along the Doppler axis.

### Technical Problem

The present disclosure is directed to providing an FMCW radar-based target extraction method and apparatus.

In addition, the present disclosure provides an FMCW radar-based target extraction method and apparatus capable of detecting only real targets by distinguishing and removing ghost targets at the receiver using a new binary code.

### Technical Solution

According to one aspect of the present disclosure, an FMCW radar-based target extraction method is provided.

According to an embodiment of the present disclosure, an FMCW radar-based target extraction method may be provided, the method comprising: (a) transmitting a radar transmit signal, the radar transmit signal being BPSK (binary phase shift keying)-modulated based on a first binary code; (b) acquiring a radar receive signal reflected by a target; (c) multiplying the radar receive signal by a second binary code to generate a ghost-target signal; and (d) removing the ghost-target signal from the radar receive signal to extract a real target signal.

The second binary code is a code not used for transmission of the radar transmit signal and may be a binary code orthogonal to the first binary code used to transmit the radar transmit signal.

The first binary code is assigned according to the following mathematical expression:

$${c}_{q} ( t ) = {\sum }_{m = 1}^{\frac{{N}_{c}}{{L}_{c}}} {g}_{p} ( t - ( m - 1 ) {L}_{c} Δ t ) ,$$

where N_{c} denotes a total number of chirps, t denotes time, L_{c} denotes a length of the binary code.

In step (d), the real target signal is extracted by subtracting the ghost-target signal from the radar receive signal.

In step (d), the real target signal is extracted according to the following mathematical expression

$${d}_{r} [ n , p ] = \vert {z}_{r} [ n , p ] \vert - δ \vert {\tilde{z}}_{r} [ n , p ] \vert$$

where, zᵣ[n, p] denotes a radar receive signal,

$${\tilde{z}}_{r} [ n , p ] = {z}_{r} [ n , p ] \times {e}^{{jc}_{{N}_{T} + 1} ( t )}$$

denotes a ghost-target signal,

$${e}^{{jc}_{{N}_{T} + 1} ( t )}$$

denotes a second binary code.

According to another aspect of the present disclosure, an FMCW radar-based target extraction apparatus is provided.

In one embodiment, the apparatus may include: a radar sensor configured to transmit a radar transmit signal and acquire a radar receive signal reflected by a target, the radar transmit signal being BPSK (binary phase shift keying)-modulated based on a first binary code; a ghost-target signal generator configured to multiply the radar receive signal by a second binary code to generate a ghost-target signal; and a target extractor configured to remove the ghost-target signal from the radar receive signal to extract a real target signal.

The target extractor may extract the real target signal by subtracting the ghost-target signal from the radar receive signal.

### Advantageous Effects

By providing the FMCW radar-based target extraction method and apparatus according to an embodiment of the present disclosure, ghost targets can be distinguished and removed at the receiver using a new binary code, thereby enabling detection of only real targets.

### STATEMENT REGARDING PRIOR DISCLOSURES BY THE INVENTOR ORA JOINT INVENTOR (Grace Period Inventor-Originated Disclosure Exception)

At least one inventor or joint inventor of the present disclosure has made related disclosures in a research paper (“Ghost Target Extraction in BPM MIMO FMCW Radar System”), at Proceedings of the 2022 Summer Conference of KIEES, Vol. 10, No. 1 (Aug. 17-20, 2022), which was also disclosed in IEEE Access on Mar. 24, 2023. All of the references are included in the information disclosure statement submitted with this application.

### BRIEF DESCRIPTION OF THE DRAWINGS

FIG. 1 is a flowchart illustrating an FMCW radar-based target extraction method according to an embodiment of the present disclosure.

FIG. 2 is a diagram illustrating binary codes used for transmission and reception according to an embodiment of the present disclosure.

FIG. 3 is a diagram exemplifying system parameters according to an embodiment of the present disclosure.

FIG. 4 is a diagram illustrating an antenna layout of a MIMO radar system and a simulation environment according to an embodiment of the present disclosure.

FIG. 5 is a diagram exemplifying target information according to an embodiment of the present disclosure.

FIG. 6 is a diagram showing Doppler shifts of spectra of codes assigned to respective transmit antenna elements according to an embodiment of the present disclosure.

FIGS. 7 and 8 are diagrams exemplifying range-Doppler maps according to an embodiment of the present disclosure.

FIG. 9 is a diagram showing ghost-target detection results according to an embodiment of the present disclosure.

FIG. 10 shows ghost-target detection results represented as a range-Doppler map according to an embodiment of the present disclosure.

FIG. 11 is a diagram showing real-target detection results according to an embodiment of the present disclosure.

FIG. 12 is a block diagram schematically illustrating an internal configuration of an FMCW radar-based target extraction apparatus according to an embodiment of the present disclosure.

### BEST MODE

In the present disclosure, singular forms include plural forms unless the context clearly indicates otherwise. In the specification, the terms “composed of” or “include,” and the like, should not be construed as necessarily including all of several components or several steps described in the specification, and it should be construed that some component or some steps among them may not be included or additional components or steps may be further included. In addition, the terms “ . . . unit’, “module”, and the like disclosed in the specification refer to a processing unit of at least one function or operation and this may be implemented by hardware or software or a combination of hardware and software.

Hereinafter, the embodiments of the present disclosure will be described in detail with reference to the accompanying drawings.

### DETAILED DESCRIPTION

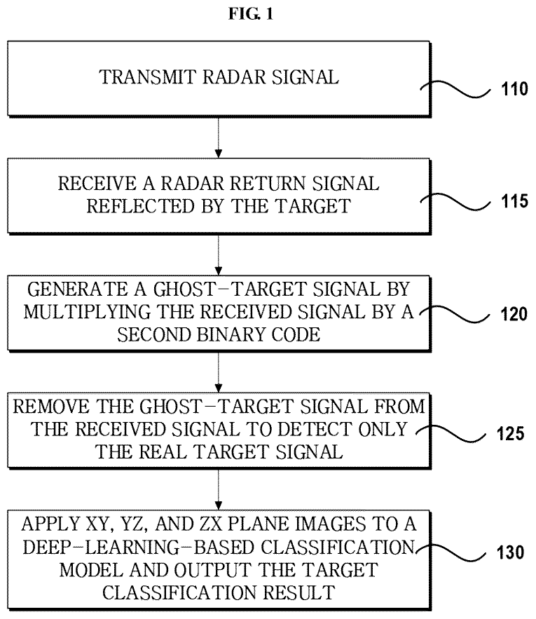

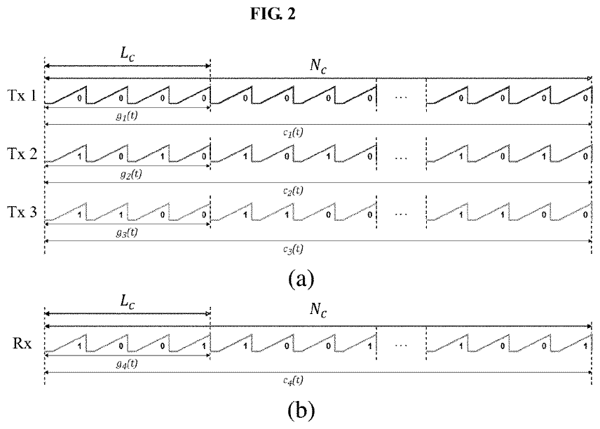

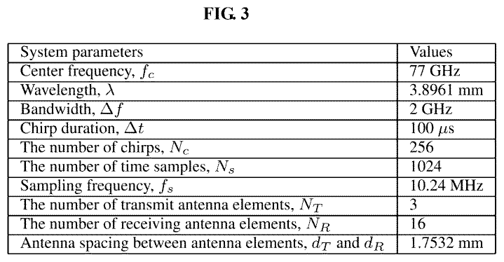

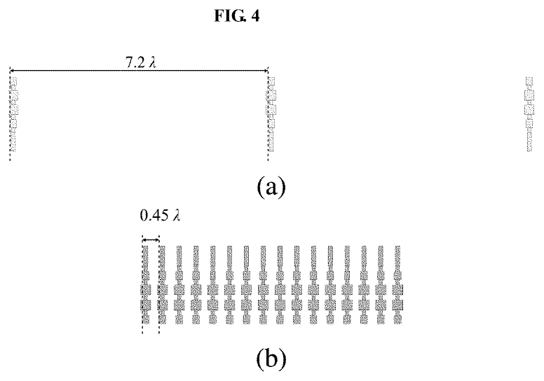

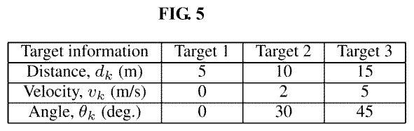

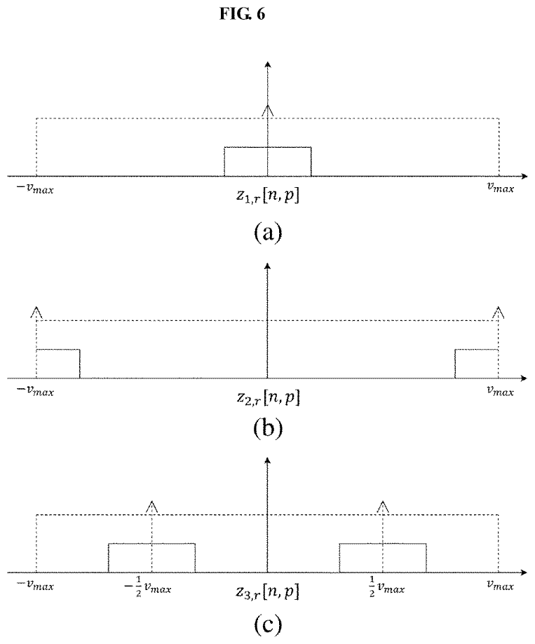

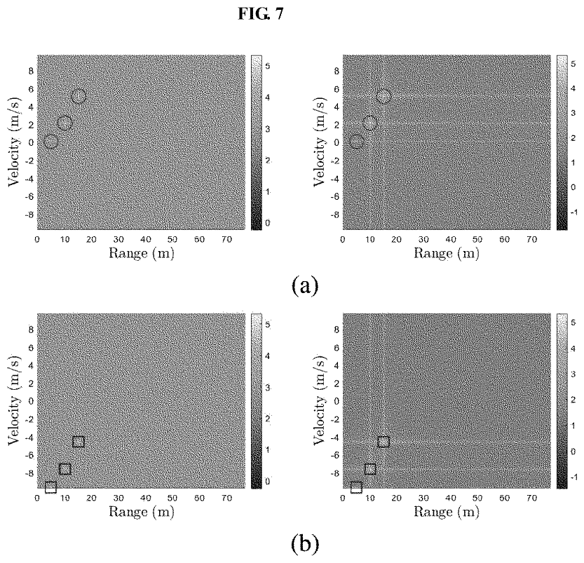

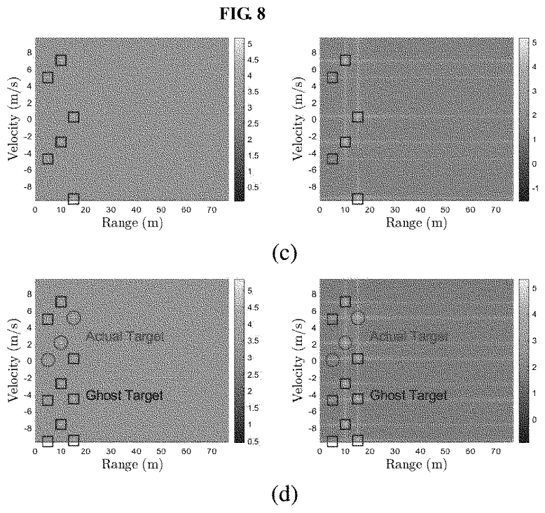

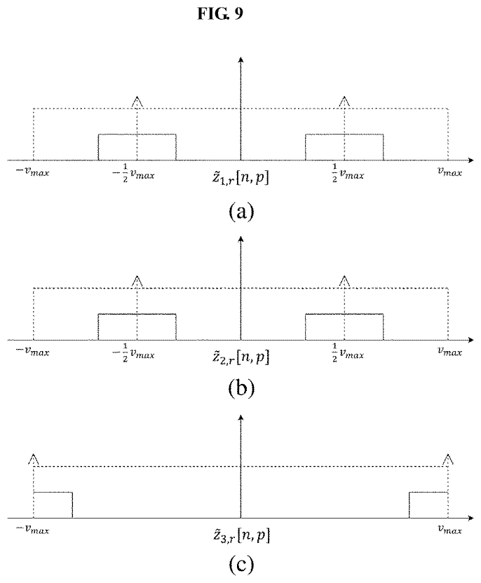

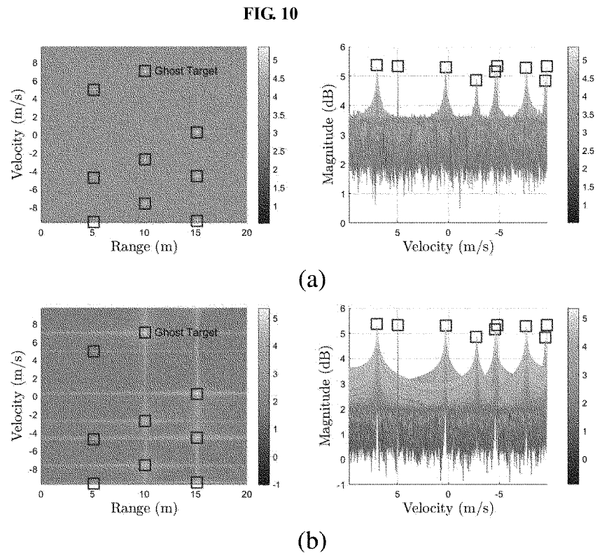

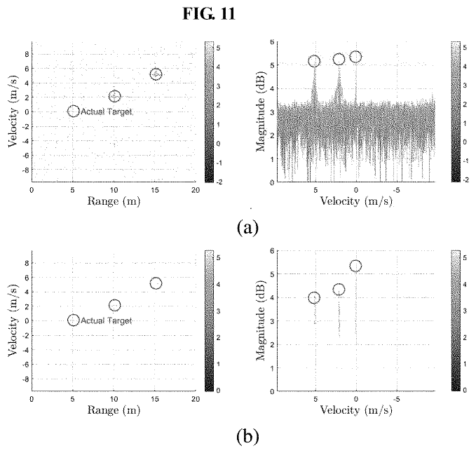

FIG. 1 is a flowchart illustrating an FMCW radar-based target extraction method according to an embodiment of the present disclosure, FIG. 2 is a diagram illustrating binary codes used for transmission and reception according to an embodiment of the present disclosure, FIG. 3 is a diagram exemplifying system parameters according to an embodiment of the present disclosure, FIG. 4 is a diagram illustrating an antenna layout of a MIMO radar system and a simulation environment according to an embodiment of the present disclosure. FIG. 5 is a diagram exemplifying target information according to an embodiment of the present disclosure, FIG. 6 is a diagram showing Doppler shifts of spectra of codes assigned to respective transmit antenna elements according to an embodiment of the present disclosure, FIGS. 7 and 8 are diagrams exemplifying range-Doppler maps according to an embodiment of the present disclosure, FIG. 9 is a diagram showing ghost-target detection results according to an embodiment of the present disclosure, FIG. 10 shows ghost-target detection results represented as a range-Doppler map according to an embodiment of the present disclosure, and FIG. 11 is a diagram showing real-target detection results according to an embodiment of the present disclosure.

In step 110, the FMCW radar-based target extraction apparatus 100 transmits a radar signal.

Here, the radar signal may be a BPSK-based FMCW radar signal.

For ease of understanding and explanation, a brief description is first provided of transmit and receive signals in a single-input/single-output (SISO) FMCW radar system.

In an FMCW radar system, the transmitted signal consists of a sequence of chirps, and the p-th chirp transmitted over (p−1)Δt≤p Δt can be expressed as Equation 1. Here, (p=1, 2, . . . , N_{c}).

$${s}_{p} ( t ) = {α}_{p} exp ( j ( 2 π ( {f}_{c} - \frac{2 p - 1}{2} Δ f ) t + π \frac{Δ f}{Δ t} {t}^{2} + {ϕ}_{p} ) ) , \qquad Equation 1$$

Here, αₚ and φₚ denote the amplitude and phase offset of the p-th chirp, respectively, and f_{C′}, Δf, Δt denote a center frequency, a bandwidth, and a duration of each chirp, respectively. A transmit signal over one period including all chirps can be expressed as Equation 2.

$$s ( t ) = \{ \begin{matrix}{s}_{p} ( t ) & for ( p - 1 ) Δ t \leq t < p Δ t \\ 0 & for {N}_{c} Δ t \leq t < Δ T ,\end{matrix} \qquad Equation 2$$

Here, ΔT denotes the transmission period.

Meanwhile, the signal received after reflection from the target can be expressed as Equation 3.

$$y ( t ) = {\sum }_{k = 1}^{{N}_{K}} {β}_{k} s ( t - {τ}_{k} ) + n ( t ) , \qquad Equation 3$$

Here, βₖ denotes the amplitude of the radar receive signal, and τₖ denotes the time delay caused by the k-th target's range (dₖ) and velocity (vₖ). In addition, N_{K} denotes the number of targets, and n(t) denotes noise added at the receive antenna element.

Considering a MIMO antenna system having N_{T} transmit antenna elements and N_{R} receive antenna elements, when the signals transmitted by all transmit antenna elements q (q=1, 2, . . . , N_{T}) are received by the r-th receive antenna element (r=1, 2, . . . , N_{R}), the radar receive signal can be expressed as Equation 4.

$${y}_{r} ( t ) = {\sum }_{q = 1}^{{N}_{T}} ( {\sum }_{k = 1}^{{N}_{K}} {β}_{k} s ( t - ( {τ}_{k} + {u}_{q , k} + {v}_{r , k} ) ) ) + {n}_{r} ( t ) , \qquad Equation 4$$

Here, nᵣ(t) denotes noise added to the r-th receive antenna element, and u_{q,k} and v_{r,x} respectively denote time delays caused by the spacing (d_{T}) between transmit antenna elements and the spacing (d_{R}) between receive antenna elements. If θₖ denotes the angle formed between the array boresight and the k-th target, the total time delay due to the antenna spacings can be expressed as Equation 5.

$${u}_{q , k} + {v}_{r , k} = \frac{2 π}{λ} ( ( q - 1 ) {d}_{T} + ( r - 1 ) {d}_{R} ) sin {θ}_{k} , \qquad Equation 5$$

Here, λ denotes the wavelength corresponding to the center frequency of the FMCW radar signal.

In a BPSK-based MIMO FMCW radar system, the FMCW radar signal transmitted from the q-th antenna element can be modulated as Equation 6.

$${x}_{q} ( t ) = s ( t ) exp ( j π {c}_{q} ( t ) ) \qquad Equation 6$$

Here, c_{q}(t) denotes the code assigned to the q-th antenna element for BPSK modulation, and, in general c_{q}(t) employs orthogonal codes to reduce cross-correlation among signals transmitted from different antenna elements. For example, a Hadamard code may be used for BPSK modulation.

In one embodiment, the total number of chirps is partitioned into units of

$$\frac{{N}_{c}}{{L}_{c}}$$

to assign the binary codes. Mathematically, this can be expressed as Equation 7.

$${c}_{q} ( t ) = {\sum }_{m = 1}^{\frac{{N}_{c}}{{L}_{c}}} {g}_{q} ( t - ( m - 1 ) {L}_{c} Δ t ) , \qquad Equation 7$$

Here, g_{q}(t) exist over 0≤t<L_{c}Δt and takes a value of +1 or −1 at every Δt.

In one embodiment, N_{c} is set to be a multiple of L_{c} so that

$$\frac{{N}_{c}}{{L}_{c}}$$

is an integer.

Moreover, the functions g_{q}(t) are mutually orthogonal, as expressed in Equation 8.

$$\frac{1}{{L}_{C} Δ t} {\int }_{0}^{{L}_{c} Δ t} {g}_{i} ( t ) {g}_{j} ( t ) dt = \{ \begin{matrix}0 & for i \neq j \\ 1 & for i = j\end{matrix} . \qquad Equation 8$$

In step 115, the FMCW radar-based target extraction apparatus 100 receives a radar receive signal reflected by the target.

In an FMCW radar system, the radar receive signal is down-converted to baseband through a frequency mixer and a low-pass filter. In general, the time delays τₖ, u_{q,k} and v_{r,x} are much smaller than Δt; thus c_{q}(t−(τₖ+u_{q,k}+v_{r,k})≅c_{q}(t). Accordingly, the signal transmitted from the q-th transmit antenna element is sampled by the ADC at the r-th receive antenna element and can be expressed as Equation 9.

$${z}_{q , r} [ n , p ] = {\sum }_{k = 1}^{{N}_{K}} {γ}_{k} {e}^{j π {c}_{q} ( {nT}_{s} + ( p - 1 ) Δ t )} \times exp ( j 2 π ( \frac{2 {d}_{k} Δ f}{c Δ t} {nT}_{s} + \frac{2 {v}_{k} {f}_{c} Δ t}{c} p + {u}_{q , k} + {v}_{r , k} + \frac{2 {d}_{k} {f}_{c}}{c} ) ) \qquad Equation 9$$

Here, n (n=1, 2, . . . , N_{S}) denotes the time-sample index within each chirp, and T_{S} denotes the sampling interval. In addition, γₖ denotes the amplitude of the k-th baseband signal. In a MIMO antenna system, the signal received by the r-th receive antenna element is the sum of the signals transmitted by all transmit antenna elements and can be expressed as Equation 10.

$${z}_{r} [ n , p ] = {\sum }_{q = 1}^{{N}_{T}} {z}_{q , r} [ n , p ] \qquad Equation 10$$

For example, consider a BPSK-based MIMO radar system with three transmit antenna elements, and assume that each antenna element uses orthogonal Hadamard codes as follows.

g₁(t)=[0, 0, 0, 0], g₂(t)=[1, 0, 1, 0], g₃(t)=[1, 1, 0, 0]. This is shown in FIG. 2. In FIG. 2, the system parameter values related to the FMCW radar were set to values commonly used in commercial automotive radars.

As presented in FIG. 3, in one embodiment, a 3×16 MIMO antenna system was assumed with an inter-element spacing of 0.45λ between all antenna elements, and the antenna layout and simulation environment of the MIMO radar system are shown in FIG. 4. The target information is shown in FIG. 5.

The signals transmitted from the respective transmit antenna elements are shifted along the Doppler axis by the assigned binary phase codes, and FIG. 6 illustrates Doppler shifts according to the spectra of the codes assigned to the respective transmit antenna elements. In the case of (a) of FIG. 6, the transmit signal coded with g₁(t) does not affect the phase; therefore, no Doppler shift appears and the detection result of the actual target is preserved. However, in (b) and (c) of FIG. 6, the transmitted signals are shifted along the Doppler axis by the binary phase codes and show different Doppler shifts depending on the spectra of the codes.

To understand the influence of the binary codes multiplied at each transmit antenna, the signal received at the r-th receive antenna element was decomposed as shown in FIG. 7 and (c) of FIG. 8. In practice, as shown in (d) of FIG. 8, the three transmit signals are received in combination. As explained with reference to FIG. 6, the position of the detected target shifts along the Doppler axis.

In one embodiment of the present disclosure, a target other than the real target is defined as a “ghost target” and the ghost target generated at the receiver can be removed so as to extract only the real target. This will be made clearer by the following description.

In step 120, the FMCW radar-based target extraction apparatus 100 multiplies the radar receive signal by a second binary code to generate a ghost-target signal. In one embodiment, the second binary code is a code not used for transmission of the transmit signal and is defined as a binary code orthogonal to the first binary code used to transmit the transmit signal.

At the receiver, N_{T}+1 codes are used for BPSK modulation; that is, the number of c_{q}(t) is not N_{T} but N_{T}+1. In this case, the transmitter uses the first through N_{T}-th codes, and the receiver uses the (N_{T}+1)-th code.

By multiplying the proposed code

$${e}^{{jc}_{{N}_{T} + 1} ( t )}$$

with zᵣ[n, p], the decoded radar receive signal can be expressed as Equation 11.

$${\tilde{z}}_{r} [ n , p ] = {z}_{r} [ n , p ] \times {e}^{{jc}_{{N}_{T} + 1} ( t )} \qquad Equation 11$$

Accordingly, when the radar receive signal is decoded using the second binary code, a Doppler shift occurs due to the binary code multiplied at the receiver, as shown in FIG. 9. Consequently, the actual target information vanishes and only the Doppler-shifted component remains.

As a result, by decoding the radar receive signal with the second binary code, the actual target information is removed and only the Doppler-shifted signal (i.e., the ghost target) can be extracted. For example, when the decoding of the radar receive signal according to one embodiment of the present disclosure is applied to the target-detection result of (d) of FIG. 8, the outcome is as shown in FIG. 10.

As shown in (b) of FIG. 2, the receiver uses c₄(t), which is orthogonal to the codes, c₁(t), c₂(t), c₃(t) used at the transmitter. As shown in FIG. 10, when the radar receive signal is multiplied by the binary code c₄(t), only the real target information disappears from the range-Doppler map.

For ease of understanding and explanation, in one embodiment of the present disclosure, the signal generated by multiplying the radar receive signal by the second binary code is referred to as a “ghost-target signal.”

In step 125, the FMCW radar-based target extraction apparatus 100 removes the ghost-target signal from the radar receive signal to extract the real target signal.

As described above, the ghost-target signal can be generated by multiplying the radar receive signal by the second binary code. Accordingly, to extract only the real target from a range-Doppler map in which the ghost target and the real target coexist, the apparatus subtracts the ghost-target signal from the radar receive signal.

Consequently, using the signals of Equations 10 and 11, only the real target can be extracted; mathematically, this is expressed by Equation 12.

$${d}_{r} [ n , p ] = \vert {z}_{r} [ n , p ] \vert - δ \vert {\tilde{z}}_{r} [ n , p ] \vert \qquad Equation 12$$

Here, & denotes a constant for compensating the difference in signal strength between the two signals zᵣ[n, p] and, \tilde{z}[n, p]. Let the maximum peak appearing in \tilde{z}ᵣ[n, p], which contains both the real and ghost targets, be denoted zᵣ. Then the minimum peak appearing \tilde{z}ᵣ[n, p] corresponds to the ghost target only. When the second binary code is multiplied, the signal is denoted by z_{r,max} and δ is set z_{r,max}/\tilde{z}_{r,min} shown in FIG. 11, subtracting the ghost-target signal from the radar receive signal removes all ghost targets, leaving only information on the real target in the range-Doppler map.

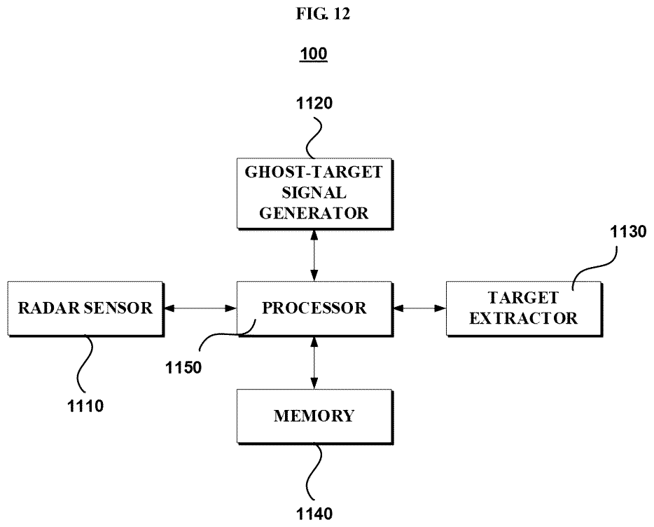

FIG. 12 is a block diagram schematically illustrating an internal configuration of an FMCW radar-based target extraction apparatus according to an embodiment of the present disclosure.

Referring to FIG. 12, an FMCW radar-based target extraction apparatus 100 according to one embodiment includes a radar sensor 1110, a ghost-target signal generator 1120, a target extractor 1130, a memory 1140, and a processor 1150.

The radar sensor 1110 is configured to transmit a radar transmit signal and acquire a radar receive signal reflected by a target. In this case, the radar transmit signal is a BPSK (binary phase shift keying)-modulated signal based on a first binary code.

The ghost-target signal generator 1120 is a means for generating a ghost-target signal by multiplying a second binary code with the radar receive signal. As described above, the second binary code is a code not used for transmission of the radar transmit signal, and may be orthogonal to the first binary code.

The target extractor 1130 is configured to remove the ghost-target signal from the radar receive signal to extract a real target signal. That is, the target extractor 1130 subtracts the ghost-target signal from the radar receive signal to eliminate the ghost target, thereby detecting only the real target.

The memory 1140 stores instructions for performing the FMCW radar-based target extraction method according to an embodiment of the present disclosure.

The processor 1150 is means for controlling the internal components of the FMCW radar-based target extraction apparatus 100 (for example, the radar sensor 1110, the ghost-target signal generator 1120, the target extractor 1130, the memory 1140, etc.).

The apparatus and method according to embodiments of the present disclosure may be implemented in the form of program instructions executable by various computer means and recorded on a computer-readable medium. The computer-readable medium may include, alone or in combination, program instructions, data files, and data structures. The program instructions recorded on the computer-readable medium may be specially designed and configured for the present disclosure, or may be known and available to those skilled in the art of computer software.

Examples of the computer-readable recording medium include magnetic media such as hard disks, floppy disks, and magnetic tapes; optical media such as CD-ROMs and DVDs; magneto-optical media such as floptical disks; and hardware devices specially configured to store and execute program instructions, such as ROM, RAM, and flash memory. The program instructions include not only machine code generated by compilers, but also high-level language code that can be executed by a computer using interpreters or the like.

The foregoing hardware devices may be configured to operate as one or more software modules to perform the operations of the present disclosure, and vice versa.

Hereinabove, the present disclosure has been described with reference to exemplary embodiments thereof. It will be understood by those skilled in the art to which the present disclosure pertains that the present disclosure may be implemented in a modified form without departing from essential characteristics of the present disclosure. Therefore, the exemplary embodiments disclosed herein should be considered in an illustrative aspect rather than a restrictive aspect. The scope of the present disclosure should be defined by the claims rather than the above-mentioned description, and all differences within the scope equivalent to the claims should be interpreted to fall within the present disclosure.

What is claimed is:

1. An FMCW radar-based target extraction method, comprising:
(a) transmitting a radar transmit signal, the radar transmit signal being BPSK (binary phase shift keying)-modulated based on a first binary code;
(b) acquiring a radar receive signal reflected by a target;
(c) multiplying the radar receive signal by a second binary code to generate a ghost-target signal; and
(d) removing the ghost-target signal from the radar receive signal to extract a real target signal.

2. The method of claim 1,
wherein the second binary code is not used to transmit the radar transmit signal and is a binary code orthogonal to the first binary code used to transmit the radar transmit signal.

3. The method of claim 1,
wherein the first binary code is assigned according to the following mathematical expression:
$${c}_{q} ( t ) = {\sum }_{m = 1}^{\frac{{N}_{c}}{{L}_{c}}} {g}_{q} ( t - ( m - 1 ) {L}_{c} Δ t ) ,$$
where N_{C} denotes a total number of chirps, t denotes time, L_{C} denotes a length of the first binary code.

4. The method of claim 1,
wherein, in step (d), the real target signal is extracted by subtracting the ghost-target signal from the radar receive signal.

5. The method of claim 1,
wherein, in step (d), the real target signal is extracted according to the following mathematical expression
$${d}_{r} [ n , p ] = \vert {z}_{r} [ n , p ] \vert - δ \vert {\tilde{z}}_{r} [ n , p ] \vert$$
where, zᵣ[n, p] denotes a radar receive signal,
$${\tilde{z}}_{r} [ n , p ] = {z}_{r} [ n , p ] \times {e}^{{jc}_{{N}_{T} + 1} ( t )}$$
denotes the ghost-target signal,
$${e}^{{jc}_{{N}_{T} + 1} ( t )}$$
denotes the second binary code.

6. A non-transitory computer-readable storage medium having program code stored thereon which, when executed by one or more processors, causes the processors to perform the method of claim 1.

7. An FMCW radar-based target extraction apparatus comprising:
a radar sensor configured to transmit a radar transmit signal and acquire a radar receive signal reflected by a target, the radar transmit signal being BPSK (binary phase shift keying)-modulated based on a first binary code;
a ghost-target signal generator configured to multiply the radar receive signal by a second binary code to generate a ghost-target signal; and
a target extractor configured to remove the ghost-target signal from the radar receive signal to extract a real target signal.

8. The apparatus of claim 7, wherein the second binary code is not used to transmit the radar transmit signal and is a binary code orthogonal to the first binary code used to transmit the radar transmit signal.

9. The apparatus of claim 7, wherein the target extractor extracts the real target signal by subtracting the ghost-target signal from the radar receive signal.
